(19) United States
(12) Patent Application Publication
(10) Pub. No.: US 2009/0046479 A1
(43) Pub. Date: Feb. 19, 2009

(54) Thin Backlight Using Low Profile Side Emitting LED

(75) Inventors: Serge J. Bierhuizen, Santa Rosa, CA (US); Gerard Harbers, Sunnyvale, CA (US); Oleg B. Shchekin, San Francisco, CA (US); Gregory W. Eng, Fremont, CA (US)

Correspondence Address: PATENT LAW GROUP LLP, 2635 NORTH FIRST STREET, SUITE 223, SAN JOSE, CA, 95134, US

(73) Assignee: PHILIPS LUMILEDS LIGHTING COMPANY, LLC, San Jose, CA (US)

(21) Appl. No.: 11/840,130

(22) Filed: Aug. 16, 2007

(51) Int. Cl. F21V 7/04; G02B 6/10

(52) U.S. Cl. 362/612; 385/146

(57) ABSTRACT

Low profile, side-emitting LEDs are described. The LEDs are used in very thin backlights for backlighting an LCD. In one embodiment, the backlight comprises a solid transparent waveguide with at least one opening in the waveguide containing an LED proximate to one edge. To smooth out a clover-shaped or batwing brightness profile inherently generated by a rectangular side-emitting LED within a smooth-sided rectangular opening in the waveguide, depending on the orientation of the LED, the sidewalls of the opening are made to have varying angles along the length of each sidewall to vary the refraction angle of light along the sidewall. Additionally, if a plurality of LEDs are used in the backlight, the orientations of the openings alternate to create a more uniform brightness profile in the waveguide.

### FIELD OF INVENTION

This invention relates to illumination devices using non-lasing light emitting diodes (LEDs) and, in particular, to techniques for improving backlights and other similar illumination devices using side-emitting LEDs.

### BACKGROUND

Liquid crystal displays (LCDs) are commonly used in cell phones, personal digital assistants (PDAs), portable music players, laptop computers, desktop monitors, and television applications. One embodiment of the present invention deals with a color or monochrome, transmissive LCD that requires backlighting, where the backlight may use one or more LEDs emitting white or colored light. The LEDs are distinguished from laser diodes in that the LEDs emit incoherent light.

In many small displays, such as for cell phones, it is important that the display and backlight be thin. Further, since such small displays are typically battery operated, it is important that the light from the LED be efficiently directed to the back surface of the LCD. It is also important that the light from the LED be substantially uniformly emitted by the backlight so as not to distort the brightness of an image displayed by the LCD.

### SUMMARY

Various non-lasing LED designs are described herein for creating an improved backlight for backlighting an LCD. The backlight may be also used for other illumination applications. The LEDs are side-emitting, where most light is emitted within a narrow area to enter the backlight waveguide (also known as a lightguide) between the top and bottom surfaces of the waveguide. In the preferred embodiment, no lenses are used to create the side emission. The LEDs have a low profile, allowing a backlight to be made very thin (e.g., 0.3-3 mm) depending on the diagonal dimension of the display or application.

The LED comprises an n-type layer, a p-type layer, and an active layer sandwiched between the n and p layers. The active layer emits blue light. The LED is a flip chip with reflective n and p electrodes on the same side of the LED. A phosphor layer (e.g., a YAG phosphor) over at least a top surface of the LED die emits a yellow light when energized by the blue light. The combination of the blue light and yellow light produce white light. The phosphor layer may instead be red and green or other combination of phosphors that cause white light to be generated. The LED may even generate UV light, and blue, red, and green phosphors are used to create white light. In another embodiment, no phosphors are used, and the color output by the LED dies is the backlight color.

A mirror layer is formed over the phosphor so that light can be emitted substantially from only the sides of the LED and phosphor. In another embodiment, two mirror layers, substantially planar with the top and bottom surfaces of the waveguide, sandwich the phosphor layer to cause light to primarily exit from the three open sides of the phosphor layer generally parallel to the mirror layers.

The LED is mounted electrode-side down on a submount. The submount is then surface mounted on a printed circuit board coupled to a power supply.

The resulting LED has a very low profile (e.g., less than 1 mm) since it is a flip chip and uses no lens for its side emission. The LED can emit white light or light of any other color.

A backlight is described where the backlight comprises a thin solid polymer (e.g., PMMA) waveguide with a bottom reflective surface and a top emitting surface. The bottom reflective surface can be a separate film on the bottom surface, which may be specular or light-scattering. The bottom reflective surface may instead be a reflective tub in which the waveguide is positioned. The backlight illuminates the back surface of a liquid crystal display (LCD). A rectangular (includes square) side-emitting LED is inserted into an opening in the waveguide near an edge of the waveguide, where the opening is slightly larger than the LED, so that the light-emitting sides of the LED are wholly between the top and bottom surfaces of the waveguide. The LED light is thereby efficiently coupled into the waveguide. The bottom surface of the waveguide has micro-prisms or other extraction features formed in it that reflect light upward to cause light to leak out the top surface of the backlight. The extraction features are typically formed by the waveguide mold. Alternatively, sandblasting, etching, screen-printing, or by other means may be used to redirect light towards the light emitting surface of the waveguide.

Due to the rectangular (includes square) shape of the LED and the flat-walled rectangular-shaped opening in the solid waveguide, the brightness profile in the waveguide, determined by equi-brightness contour lines, is non-uniform. This is because the light emission from the LED toward a corner of the rectangular waveguide opening is refracted at the waveguide interface toward the normal of the sidewall away from the corner. As a result, there is a diminished brightness in the waveguide at the corner areas. As a result, if the rectangular opening in the waveguide is located so that a flat side of the LED is parallel to the near edge of the waveguide, a clover-shaped brightness profile in the waveguide occurs. If the rectangular opening in the waveguide is located so that a flat side of the LED is 45 degrees relative to the near edge of the waveguide, a “batwing” shaped brightness profile in the waveguide occurs.

Applicants have discovered that, if the walls of the opening in the waveguide for the rectangular LED are not flat but have varying angles (or varying diffractive structures) relative to the sides of the LED, the different refractions caused by the different angles smoothes out the effects of the edge refractions into the waveguide so the brightness profile in the waveguide is substantially uniform (like a semicircle). The varying edge refractions of the opening can also be formed to co-act with a particular pattern of the waveguide extraction features to create a substantially uniform backlight emission.

In one embodiment, the walls of the opening in the waveguide are scalloped shaped. In another embodiment, each wall has a plurality of flat portions with a plurality of angles along the length of the wall.

In another embodiment, there are multiple openings in the waveguide near an edge, where each opening contains an LED. This enables the waveguide to output more light, such as for a larger waveguide, and more uniformly distributes the light.

When multiple openings are used, the openings may alternate between those with a side parallel to the edge of the waveguide and those with a side 45 degrees relative to the edge of the waveguide. If the walls of the opening are smooth, the clover-shaped brightness profiles from some LEDs compensate for the batwing brightness profiles from adjacent LEDs to produce a combined brightness profile into the waveguide that is far more uniform than the individual brightness profiles. Other combinations of the orientations of the openings would also work well.

By varying the angles, shapes, or diffractive features along the lengths of the opening sidewalls (e.g., scalloped walls) with varying the orientations of the openings, even greater uniformity is achieved.

### BRIEF DESCRIPTION OF THE DRAWINGS

FIG. 1 is a cross-sectional view of a low profile, side-emitting LED in accordance with an embodiment of the invention.

FIG. 2 is a cross-sectional view of a backlight cut through the LED in accordance with an embodiment of the invention.

FIGS. 3 and 4 are cross-sectional views of two different types of waveguides that may be used in the present invention.

FIG. 5 is a top down view of a backlight with a single LED positioned in an opening with flat walls, used to show certain drawbacks in the inventors' earlier designs.

FIG. 6 illustrates the batwing brightness profile into the waveguide of FIG. 5.

FIG. 7 is a top down view of a backlight with a single LED positioned in an opening with flat walls, but having an orientation different from that shown in FIG. 5, where the resulting brightness profile has a clover-shape.

FIG. 8 is a top down view of a backlight in accordance with one embodiment of the present invention, where openings for LEDs having a variety of orientations are used to offset the brightness profile non-uniformities shown in FIGS. 6 and 7, resulting in a substantially uniform overall brightness profile into the waveguide.

FIG. 9 is similar to FIG. 8 but with a different order of opening orientations.

FIGS. 10, 11, 12, and 13 are close up, top down views in accordance with one embodiment of the invention, where the walls of the opening in the waveguide have varying angles, causing varying refractions of the light, to create a substantially uniform brightness profile in the waveguide.

FIG. 14 is a top down view of a backlight illustrating how multiple LEDs may be arranged along an edge of a waveguide.

FIG. 15 is a perspective view of an LED with a thick coating of titanium oxide over the top surface and three sides to diffusively reflect light so that light is only emitted from one edge of the LED.

FIG. 16 illustrates a backlight where the waveguide opening has only a single sidewall facing into the waveguide with varying angles.

FIG. 17 illustrates a backlight where the waveguide opening has three sidewalls with varying angles, and the rear edge of the waveguide has varying angles.

Elements that are similar or identical in the various figures are labeled with the same numeral.

### DETAILED DESCRIPTION

Embodiments of the present invention comprise low profile side-emitting LEDs in conjunction with thin waveguide designs for providing a uniform light emitting surface. A typical application for the invention is as a thin backlight in an LCD.

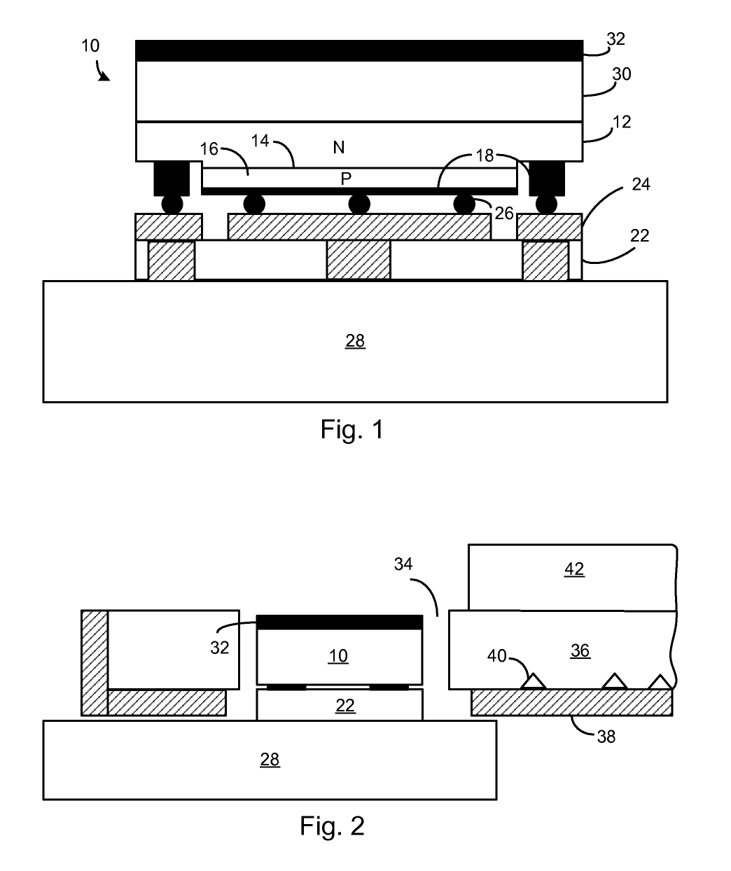

FIG. 1 is a cross-sectional view of one embodiment of a thin, side-emitting LED 10. Other embodiments of thin, side-emitting LEDs that may be used in the backlight embodiments can be found in U.S. application Ser. No. 11/423,419, entitled Low Profile Side Emitting LED, filed Jun. 9, 2006, by Oleg Shchekin et al., assigned to the present assignee, and incorporated herein by reference.

The active layer of the LED 10 in one example generates blue light. LED 10 is formed on a starting growth substrate, such as sapphire, SiC, or GaN. Generally, an n-layer 12 is grown followed by an active layer 14, followed by a p-layer 16. The p-layer 16 is etched to expose a portion of the underlying n-layer 14. Reflective metal electrodes 18 (e.g., silver, aluminum, or an alloy) are then formed over the surface of the LED to contact the n and p layers. When the diode is forward biased, the active layer 14 emits light whose wavelength is determined by the composition of the active layer (e.g., AlInGaN). Forming such LEDs is well known and need not be described in further detail. Additional detail of forming LEDs is described in U.S. Pat. No. 6,828,596 to Steigerwald et al. and U.S. Pat. No. 6,876,008 to Bhat et al., both assigned to the present assignee and incorporated herein by reference.

The semiconductor LED is then mounted on a submount 22 as a flip chip. The submount 22 contains metal electrodes 24 that are soldered or ultrasonically welded to the metal 18 on the LED via solder balls 26. Other types of bonding can also be used. The solder balls 26 may be deleted if the electrodes themselves can be ultrasonically welded together.

The submount electrodes 24 are electrically connected by vias to pads on the bottom of the submount so the submount can be surface mounted to metal pads on a printed circuit board 28. Metal traces on the circuit board 28 electrically coupled the pads to a power supply. The submount 22 may be formed of any suitable material, such as ceramic, silicon, aluminum, etc. If the submount material is conductive, an insulating layer is formed over the substrate material, and the metal electrode pattern is formed over the insulating layer. The submount 22 acts as a mechanical support, provides an electrical interface between the delicate n and p electrodes on the LED chip and a power supply, and provides heat sinking. Submounts are well known.

To cause the LED 10 to have a very low profile, and to prevent light from being absorbed by the growth substrate, the growth substrate is removed, such as by CMP or using a laser lift-off method, where a laser heats the interface of the GaN and growth substrate to create a high-pressure gas that pushes the substrate away from the GaN. In one embodiment, removal of the growth substrate is performed after an array of LEDs is mounted on a submount wafer and prior to the LEDs/submounts being singulated (e.g., by sawing).

After the growth substrate is removed, a planar phosphor layer 30 is positioned over the top of the LED for wavelength-converting the blue light emitted from the active layer 14. The phosphor layer 30 may be preformed as a ceramic sheet and affixed to the LED layers, or the phosphor particles may be thin-film deposited, such as by electrophoresis. The phosphor ceramic sheet may be sintered phosphor particles or phosphor particles in a transparent or translucent binder, which may be organic or inorganic. The light emitted by the phosphor layer 30, when mixed with blue light, creates white light or another desired color. The phosphor may be a yttrium aluminum oxide garnet (YAG) phosphor that produces yellow light (Y+B=white), or may be a combination of a red phosphor and a green phosphor (R+G+B=white).

With a YAG phosphor (i.e., Ce:YAG), the color temperature of the white light depends largely on the Ce doping in the phosphor as well as the thickness of the phosphor layer 30.

A reflective film 32 is then formed over the phosphor layer 30. The reflective film 32 may be specular or diffusing. A specular reflector may be a distributed Bragg reflector (DBR) formed of organic or inorganic layers. The specular reflector may also be a layer of aluminum or other reflective metal, or a combination of DBR and metal. A diffusing reflector may be formed of a metal deposited on a roughened surface or a diffusing material such as a suitable white paint or a sol-gel solution with TiO2 in silicone. The phosphor layer 30 also helps to diffuse the light to improve light extraction efficiency. In another embodiment, a reflector is spaced away from the LED, such as a reflector supported by the waveguide over the active layer, resulting in the LED still being a side-emitting LED since little or no direct light exits the backlight above the LED.

Although side-emitting lenses are sometimes used to divert all light emitted by an LED's top surface into a circular side-emission pattern, such lenses are many times the thickness of the LED itself and would not be suitable for an ultrathin backlight.

In another embodiment of a side-emitting LED (not shown), two mirror layers are formed over opposite sides of the phosphor layer, perpendicular to the semiconductor LED layers, to sandwich the phosphor layer. Light then exits the three open sides of the phosphor layer generally parallel to the mirror layers to enter the backlight waveguide. Any LED that emits light within primarily a narrow area and/or angle between the top and bottom surfaces of the backlight waveguide is considered a side-emitting LED in this disclosure.

Processing of the LED semiconductor layers may occur before or after the LED is mounted on the submount 22.

Most light emitted by the active layer 14 is either directly emitted through the sides of the LED, or emitted through the sides after one or more internal reflections. If the top reflector 32 is very thin, some light may leak through the top reflector 32. Generally, for a side-emitting LED, less than 10% of the light leaks through the reflector layer.

In one embodiment, the submount 22 has a thickness of about 380 microns, the semiconductor layers have a combined thickness of about 5 microns, the phosphor layer 30 has a thickness of about 200-300 microns, and the reflective film 32 has a thickness of about 100 microns, so that the LED plus the submount is less than 1 mm thick. Of course, the LED 10 can be made thicker. The length of each side of the LED is typically less than 1 mm.

Side-emitting flip-chip LEDs provide a number of advantages when used in lighting systems. In backlights, side-emitting flip chip LEDs allow utilization of thinner waveguides, fewer LEDs, better illumination uniformity, and higher efficiency due to better coupling of light into a waveguide.

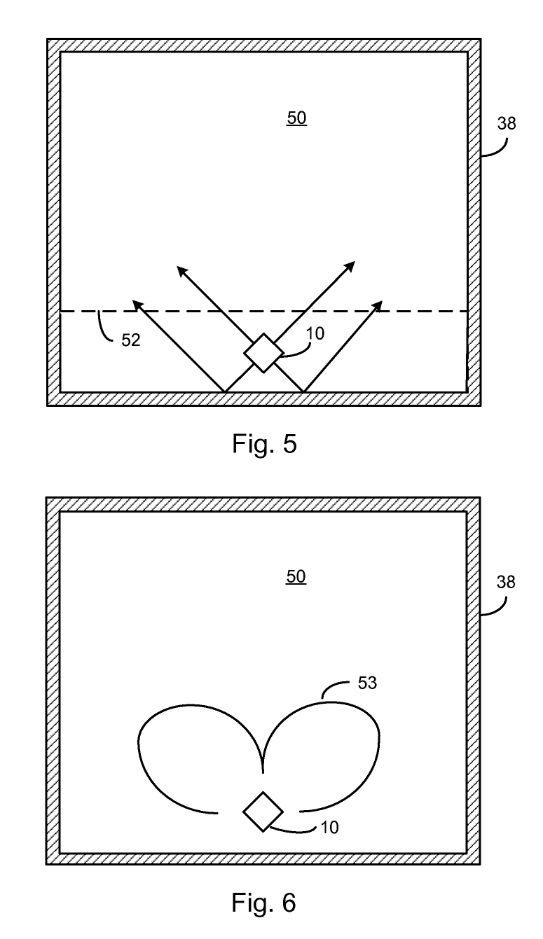

FIG. 2 is a cross-sectional view of a backlight cut across the LED 10. FIGS. 5-14 are top down views of the backlight.

In FIG. 2, the side-emitting LED 10, mounted on a circuit board 28, is inserted into a hole 34 in a solid transparent waveguide 36. There is a small air gap, such as 25 microns, between the LED 10 and the walls of the hole to accommodate positioning tolerances. The waveguide 36 may be molded plastic (e.g., PMMA) or another suitable material. A mirror film 38 covers the bottom surface and sides of the waveguide 36. The film 38 may be Enhanced Specular Reflector (ESR) film available from 3M Corporation or an external diffuse white scattering plate. It is optional that the mirror film 38 or the external white plate cover the sides. Instead of using a reflective film, the waveguide 36 may be supported in a carrier with reflective side walls.

The bottom surface of the waveguide 36 has many small pits 40 for scattering the light in an upward direction toward the LCD 42 back surface. The pits 40 may be created in the molding process for the waveguide 36 or may be formed by etching, sand blasting, printing, or other means. The pits 40 may take any form such as prisms or a random roughening. Such features are sometimes referred to as extraction features. In one embodiment, the density of the pits 40 nearer the LED 10 (where the light from the LED is brighter) is less than the density of the pits 40 further from the LED 10 to create a uniform light emission over the top surface of the waveguide 36.

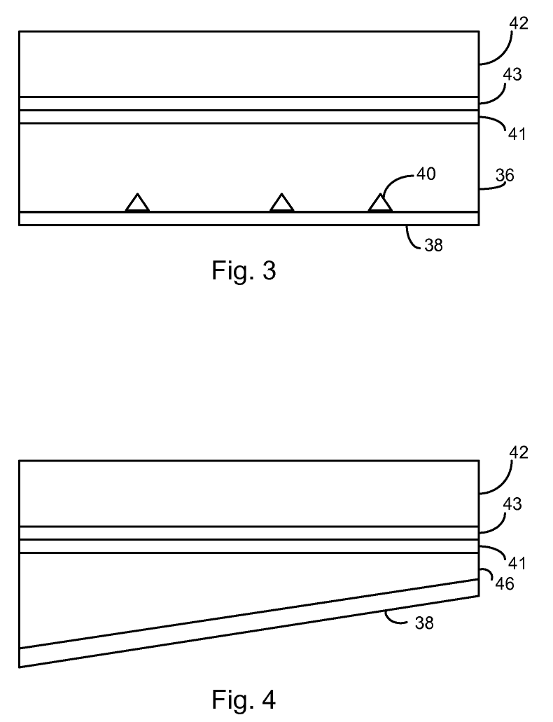

FIG. 3 is a cross-section of an embodiment of the waveguide 36 showing more detail. A thin diffuser film 41 is affixed over the top surface of the waveguide 36 to diffuse the light scattered by the pits 40. A Brightness Enhancement Film (BEF) 43 redirects light to within a relatively small angle directly in front of the waveguide 36 to increase the brightness in the normal viewing direction. A conventional color or monochrome LCD 42 overlies the waveguide 36, where the waveguide 36 acts as a backlight. The LCD can produce color images using pixel shutters (e.g., a liquid crystal layer in combination with a TFT array), polarizers, and RGB filters. Such LCDs are well known.

FIG. 4 illustrates a different type of waveguide 46, shaped as a wedge, where light is inherently reflected upward due to the angled bottom surface. Pits may be formed in the bottom surface to also reflect light upward. The wedge shape makes the backlight more efficient.

The practical total thickness of the waveguide may be between 300-800 microns, which may be approximately equal to the thickness of the light emitting portion of the side-emitting LED 10. Therefore, the entire light emitting portion of the LED 10 is optically coupled to the waveguide. For large displays, the backlight may be much thicker, such as 5-10 mm.

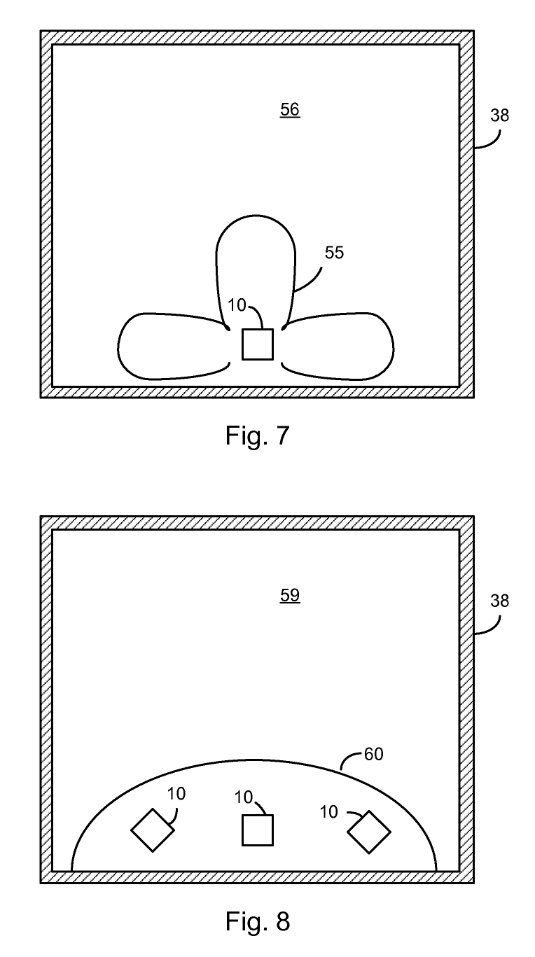

FIG. 5 is a top down view of an example of a backlight, also invented by the present inventors, that has drawbacks solved by the present invention. The bottom portion of the waveguide 50 below dashed line 52 may be blocked by a housing of the LCD due to the light being too bright around the LED 10. The angled orientation of the LED 10 was an advancement over the LED 10 being positioned with its side parallel to the edge of the waveguide (shown in FIG. 7), since better mixing was accomplished within the waveguide. However, due to the refraction of light by the flat walls of the waveguide opening, causing light rays to diverge away from the corners, the light intensity near the LED 10 corners is less than the intensity directly in front of the sides. This produced a “batwing” brightness profile 53, shown in FIG. 6, where the brightness profile line is an equal brightness line. Of course, the brightness profile becomes diffused further into the waveguide 50 as the light is mixed within the waveguide 50. The present inventors sought to further improve the uniformity of light throughout the waveguide to make it easier for the waveguide extraction features to create a uniform backlight.

FIG. 7 illustrates a worse brightness profile, a clover-shaped pattern 55, from the LED 10 positioned with its side parallel to the edge of the waveguide 56. Since the center of the clover extends into the waveguide 56, the center of the waveguide 56 is brighter than near the sides.

FIG. 8 illustrates one embodiment of the present invention. By mixing the orientations of the LEDs 10 within the waveguide 58, the clover-shape brightness profile and the batwing brightness profile overlap and combine to create a much more uniform profile 60. In FIG. 8, LEDs 10 having a 45 degree orientation are located on opposite sides of an LED 10 that has a 0 degree orientation. Any number of alternating orientations of LEDs may be used depending on the size of the backlight and the desired brightness. Having multiple LEDs also averages the slightly different color temperatures emitted by the different LEDs. Therefore, the LEDs can be selected to produce the target white point of the backlight. It is not essential that alternate LEDs 10 be offset by 45 degrees since the offsetting of the individual brightness profiles occurs to various degrees by any mixing of different LED orientations. For examples, the LEDs may be offset by 30-60 degrees.

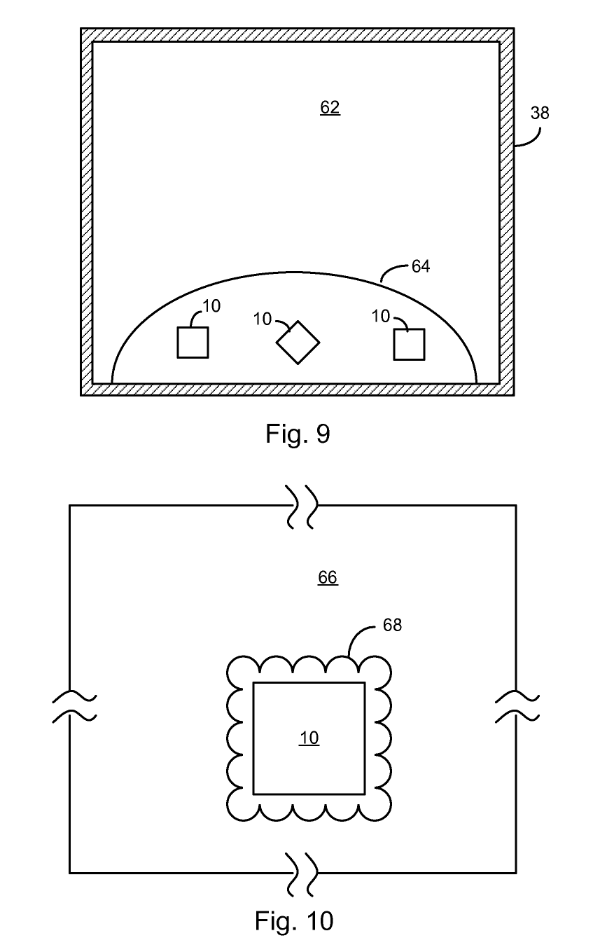

FIG. 9 illustrates another embodiment of a waveguide 62 where LEDs 10 having a 0 degree orientation are located on opposite sides of an LED 10 that has a 45 degree orientation. The brightness profiles overlap and combine to create a much more uniform brightness profile 64. The angles can be optimized for best uniformity, so are not required to be exactly 45 degrees relative to each other.

It is preferable that the LED 10 arrangement be symmetrical along an edge of the waveguide.

FIG. 10 illustrates another embodiment of the invention that may optionally be used in conjunction with the inventions of FIGS. 8 and 9. FIG. 10 illustrates only a portion of the waveguide 66. The waveguide construction may be similar to that describe above. The opening 68 for the LED 10 (or for each of a plurality of LEDs 10) has walls with varying angles to refract and reflect the light emitted by the LED 10 at different angles so the light is spread more evenly. Instead of the clover-shaped pattern (FIG. 7) that would result if the walls were flat, the different light refractions from the varying angles of the walls blend the light from adjacent sides of the LED 10 to fill in the clover pattern to create a uniform pattern, similar to the pattern 64 in FIG. 9.

The scallop shape of the walls is only one of many suitable shapes for the walls, and the number of scallops along each wall is not critical. The LED 10 may be angled at 45 degrees in any of the embodiments for a more uniform pattern.

The shaping of the sidewall(s) of the opening pointing toward the bottom reflective edge of the waveguide does not have as much effect as the shaping of the other sidewalls, since light emitted through the sidewall(s) pointing toward the bottom edge are somewhat mixed after being reflected off the bottom edge of the waveguide. Accordingly, shaping of the bottom facing sidewall(s) is optional.

The shape of the sidewalls may also be varied based on the distribution of the extraction features formed on the bottom surface of the waveguide to achieve the most uniform brightness profile at the light output of the backlight.

Simply providing a circular opening would not be sufficient to blend the light from adjacent sides of the LED and, in fact, would most likely worsen the emission pattern. Further, the added distance from the square side emitting LED to the waveguide with a round hole would result in additional light losses.

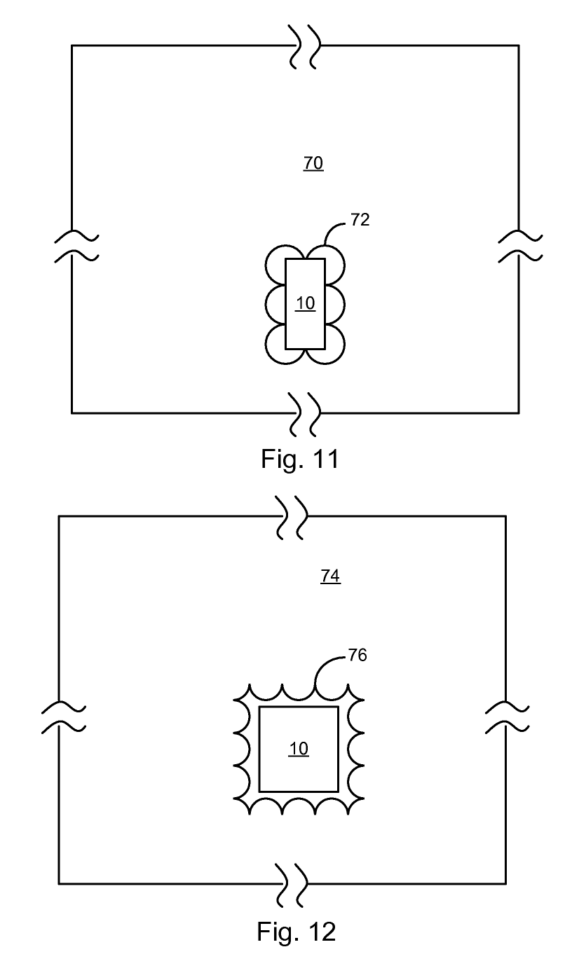

FIG. 11 illustrates another embodiment of a waveguide 70 where the opening 72 only has two or three scallops per side. In FIG. 11, it can be better understood how light from adjacent sides is refracted at an angle to fill in the clover-shaped profile, since light emitted from a side of the LED is refracted toward its nearest corner.

FIG. 12 illustrates an embodiment of a waveguide 74 where the opening 76 sidewalls are inverted scallops to achieve improved uniformity.

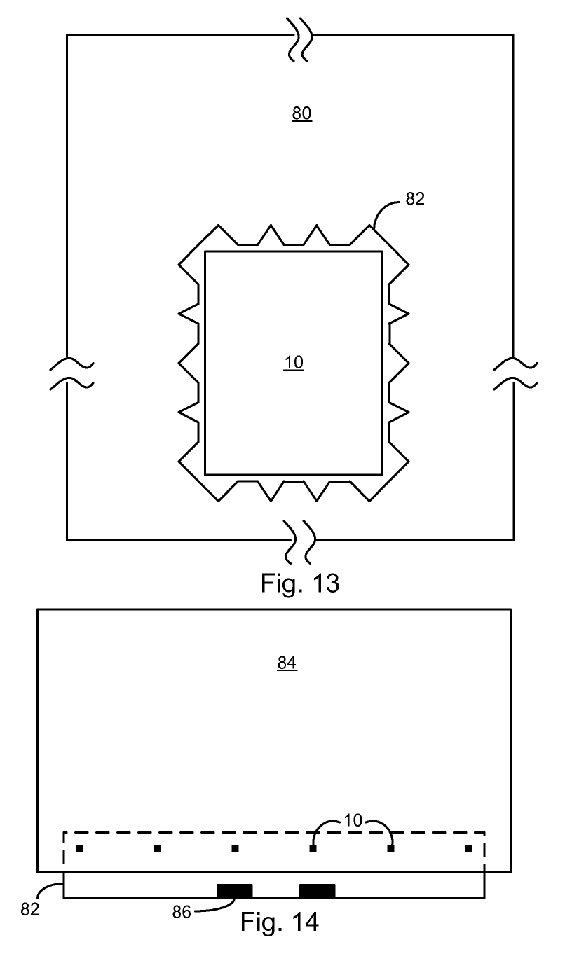

FIG. 13 illustrates an embodiment of a waveguide 80 where the opening 82 sidewalls have varying angles of 45, 30, and 0 degrees relative to the LED sides to achieve improved uniformity. Other angles can also be used.

In another embodiment, either angled or flat walls of the opening may have a diffraction coating or be patterned with a diffraction grating to redirect light at different angles along a single wall. Alternatively, a Fresnel pattern may be molded into the walls of an opening to redirect the light through a variety of angles. For example, the sides of the opening in FIG. 5 or the sides of the opening in FIG. 13 have a diffraction pattern or a Fresnel lens pattern formed in it by molding to create a more uniform brightness profile in the waveguide. Diffraction optics and Fresnel lenses are well known.

The two general embodiments of the invention (i.e., combining different LED orientations and varying refraction angles by a sidewall) have been tested, either by prototypes or by simulation, to prove the improvement in light emission uniformity over prior designs.

The above embodiments of waveguides using 1-3 LEDs may be used for small LCDs, such as for cameras, cell phones, and music players, where the screen is up to about 3 inches in width. With significantly larger screens, many more white light LEDs may be distributed along and edge.

FIG. 14 illustrates how six LEDs 10, mounted on a single circuit board strip 82, are inserted into respective openings in a plastic waveguide 84. The openings and orientations may be any of those described above. Two electrodes 86 on the circuit board strip 82 are shown that connect to a power supply. In one embodiment, a bottom portion of the waveguide 84 is thinned where the circuit board strip 82 is located to act as a guide slot for the strip 82 and to properly position the LEDs 10 within the openings. This also reduces the overall thickness of the backlight and circuit board. The circuit board strip 82 is then clamped in place by the housing of the LCD.

As an alternative to the arrangement of the LEDs 10 in FIG. 14, the LEDs 10 may be arranged in two groups of threes using the mixed orientations of FIG. 8 or 9. The LEDs in each group would be relatively close together to better mix the emission patterns.

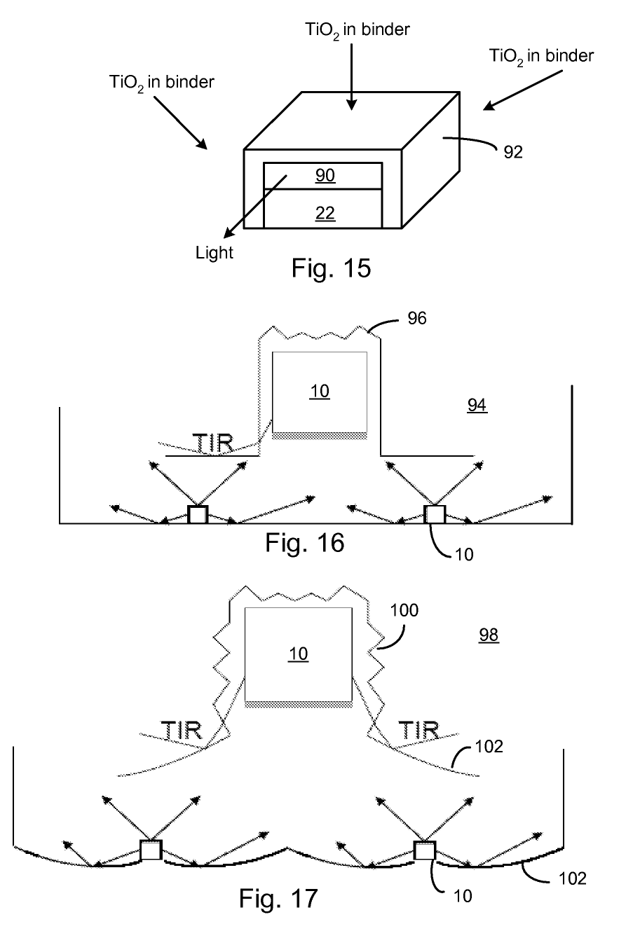

FIG. 15 is a perspective view of an LED 90, having a phosphor layer, mounted on a submount 22, with a titanium oxide layer 92 over the top surface and three sides to diffusively reflect light so that light is only emitted from one edge of the LED 90. The TiO₂ layer 92 comprises TiO₂ particles in a binder. The density of the TiO₂ particles in the binder and the thickness of the layer 92 results in the TiO₂ particles diffusively reflecting light back into the LED 90 so light can only escape from one edge of the LED 90. Such a side-emitting LED may be used in any of the backlight embodiments described herein. The light emitting opening would be typically facing into the waveguide.

In another embodiment, the TiO₂ layer 92 covers only the top and one side of the LED so that light is emitted from three sides of the LED. The side that is covered with the TiO₂ layer faces away from the center of the waveguide.

FIG. 16 illustrates another embodiment of a waveguide 94 that may use the LED of FIG. 15 or use any of the other side-emitting LEDs 10 described herein. A close up of the LED 10 and opening is superimposed over the waveguide for illustrating the details. The opening in the waveguide 94 is formed at the rear edge of the waveguide so as to only have three sidewalls. In such a case, the LED would have at least the rear edge covered with a reflector. The front sidewall 96 is formed to have varying angles to create a more uniform distribution of light into the waveguide 94. Light exiting the left and right sides of the LED is internally reflected by the side and rear edges of the waveguide 94 so become mixed and substantially uniform.

FIG. 17 illustrates a waveguide 98 similar to that of FIG. 16 but where the waveguide opening has three sidewalls 100 with varying angles, and the rear edge 102 of the waveguide has varying angles to better mix the light reflecting off the rear edge 102.

In all embodiments, the opening or hole in the waveguide need not extend completely through the waveguide. The LED's submount may be within the opening or below the waveguide, as long as the light emitting portion of the LED is within the opening.

Having described the invention in detail, those skilled in the art will appreciate that given the present disclosure, modifications may be made to the invention without departing from the spirit and inventive concepts described herein. Therefore, it is not intended that the scope of the invention be limited to the specific embodiments illustrated and described.

What is claimed is:

1. A light emitting device comprising:
a side-emitting, non-lasing light emitting diode (LED); and
a waveguide having a top surface through which light is emitted, the waveguide having at least one opening in which the side-emitting LED is positioned, whereby light emitted from sides of the LED is optically coupled into the waveguide,
the at least one opening in the waveguide having sidewalls, at least one sidewall not being flat but having varying features along a length of the sidewall to redirect light emitted from the LED through a variety of angles.

2. The device of claim 1 wherein the at least one sidewall is scalloped shaped.

3. The device of claim 1 wherein the at least one sidewall has a variety of angular shapes.

4. The device of claim 1 wherein each opening has four sidewalls, wherein each of the sidewalls has varying angles along a length of the sidewall to vary a refraction of light along the sidewall.

5. The device of claim 1 wherein each opening has three sidewalls, wherein at least one of the sidewalls has varying angles along a length of the sidewall to vary a refraction of light along the sidewall.

6. The device of claim 1 wherein each opening has two sidewalls, wherein each of the sidewalls has varying angles along a length of the sidewall to vary a refraction of light along the sidewall.

7. The device of claim 1 wherein the at least one sidewall has diffraction optics along the sidewall.

8. The device of claim 1 wherein the LED has an active layer and a reflector overlying the active layer, the active layer and a bottom surface of the reflector being wholly located between a top surface plane and a bottom surface plane of the waveguide.

9. The device of claim 1 wherein the waveguide has a thickness less than 2 mm.

10. The device of claim 1 wherein the LED has a thickness less than 2 mm.

11. The device of claim 1 further comprising a submount on which the LED is mounted.

12. The device of claim 1 wherein the LED comprises a phosphor layer.

13. The device of claim 12 wherein the LED, including the phosphor layer, emits a type of white light.

14. The device of claim 12 wherein the phosphor layer comprises two or more types of phosphors.

15. The device of claim 1 wherein the LED comprises a layer of yttrium aluminum oxide garnet.

16. The device of claim 1 wherein the LED includes a sapphire layer.

17. The device of claim 1 wherein light emitting sides of the LED have a height less than 0.4 mm.

18. The device of claim 1 wherein a semiconductor portion of the LED emits blue light.

19. The device of claim 1 wherein a bottom surface of the waveguide scatters light toward the top surface.

20. The device of claim 1 wherein the waveguide has a rectangular shape with substantially flat sides, and wherein the LED has a rectangular shape with sides that are not parallel with respect to the sides of the waveguide.

21. The device of claim 1 further comprising a liquid crystal layer overlying the waveguide for selectively controlling pixels in a display screen.

22. The device of claim 1 wherein the at least one opening comprises a plurality of openings, wherein each opening has at least one sidewall with varying refraction properties along a length of the sidewall to vary a refraction of light along the sidewall.

23. The device of claim 1 wherein the LED has a reflector attached to the remainder of the LED without an air gap.

24. The device of claim 1 wherein the LED has a reflector not directly attached to the remainder of the LED.

25. A light emitting device comprising:
a plurality of side-emitting, non-lasing light emitting diodes (LEDs); and
a waveguide having a top surface through which light is emitted, the waveguide having a plurality of openings, wherein a side-emitting LED is positioned within each opening, whereby light emitted from sides of the LEDs is optically coupled into the waveguide,
the openings being proximate to an edge of the waveguide, the openings comprising an opening of a first type having sidewalls at first and second angles relative to sides of the waveguide, the openings also comprising an opening of a second type having sidewalls at third and fourth angles relative to the sides of the waveguide, wherein the first and second angles are different from the third and fourth angles.

26. The device of claim 25 wherein the first angle is substantially parallel to certain sides of the waveguide, and the second angle is substantially perpendicular to other sides of the waveguide, and wherein the third angle and fourth angle are at substantially 45 degree angles relative to sides of the waveguide.

27. The device of claim 25 wherein there are at least three openings, an arrangement of openings along the edge of the waveguide alternating between an opening of the first type and an opening of the second type.

28. The device of claim 25 wherein there are at least three openings, an arrangement of openings along the edge of the waveguide alternating between an opening of the second type and an opening of the first type.

29. The device of claim 25 wherein the waveguide has a thickness less than 2 mm.

30. The device of claim 25 wherein the LED has a thickness less than 2 mm.

31. The device of claim 25 wherein the LED further comprises a phosphor layer, wherein the LED, including the phosphor layer, emits a type of white light.

32. The device of claim 25 further comprising a liquid crystal layer overlying the waveguide for selectively controlling pixels in a display screen.
